(19) United States
(12) Patent Application Publication
(10) Pub. No.: US 2011/0043619 A1
(43) Pub. Date: Feb. 24, 2011

(54) Resolution-Enhanced Luminescence Microscopy

(76) Inventor: Ralf Wolleschensky, Jena (DE)

Correspondence Address: DUANE MORRIS LLP - NY;PATENT DEPARTMENT, 1540 BROADWAY, NEW YORK, NY, 10036-4086, US

(21) Appl. No.: 12/990,455

(22) PCT Filed: Apr. 25, 2009
(86) PCT No.: PCT/EP09/03036

§ 371 Date: Oct. 29, 2010

(30) Foreign Application Priority Data
Apr. 30, 2008 (DE) 10 2008 021 641.0

(51) Int. Cl. H04N 7/18

(52) U.S. Cl. 348/79; 348/E07.085

(57) ABSTRACT

Described is a method for the high spatial resolution luminescence microscopy of a sample which is marked with marking molecules which can be activated by way of a switch-over signal such that only then can they be stimulated to emit luminescent radiation, wherein the method has the following steps a) introducing the switch-over signal onto the sample such that only a partial amount of the marking molecules present in the sample are activated, wherein, partial regions exist in the sample, in which partial regions only exactly one molecule, which is activated by the switch-over signal, is located inside a volume which is delimited by a diffraction-limited maximum resolution of a detection of luminescent radiation, b) stimulating the activated molecules to emit luminescent radiation, c) detecting the luminescent radiation with diffraction-limited resolution and d) generating image data from the luminescent radiation recorded in step c), wherein the marking molecules, which emit the geometric locations of the luminescent radiation, indicate with a spatial resolution which is increased to above the diffraction limit, wherein e) the detection of the luminescent radiation in step c) or the generation of the image data in step d) comprises a non-linear increase, which prefers higher intensities, of recorded luminescent radiation in order to enhance the spatial resolution to above the diffraction-limited resolution.

The present application is a U.S. National Stage application of International PCT Application No. PCT/EP2009/003036 filed on Apr. 25, 2009 which claims priority benefit of German Application No. DE 10 2008 021 641.0 filed on Apr. 30, 2008, the contents of each are incorporated by reference in their entirety.

### FIELD OF THE INVENTION

The invention relates to a method for the high spatial resolution luminescence microscopy of a sample that is marked with marking molecules that can be activated with a switch-over signal, so that only then can they be excited for the emission of defined luminescent radiation, wherein the method has the following steps:
a) introduction of the switch-over signal to the sample such that only a subset of the marking molecules present in the sample is activated, wherein, in the sample, subareas exist in which activated molecules have a distance to the activated marking molecules most closely adjacent to these activated molecules, wherein this distance is greater than or equal to an optical resolution of a detection of luminescent radiation;
b) excitation of the activated molecules for the emission of luminescent radiation;
c) detection of the luminescent radiation with the limited resolution; and
d) generation of image data from the luminescent radiation recorded in step c), wherein the data specifies the geometric positions of the luminescent-radiation-emitting marking molecules at a spatial resolution increased past the resolution limit.

The invention further relates to a device for high spatial resolution fluorescence microscopy of a sample that is marked with marking molecules that can be activated with a switch-over signal, so that only then can they be excited for the emission of defined luminescent radiation, wherein the device has: means for the introduction of the switch-over signal to the sample such that only a subset of the marking molecules present in the sample is activated, wherein, in the sample, subareas exist in which activated molecules have a distance to the activated marking molecules most closely adjacent to these activated molecules, wherein this distance is greater than or equal to an optical resolution of a detection of luminescent radiation; means for the excitation of activated molecules for the emission of luminescent radiation; a detector device that records luminescent radiation with the limited resolution and outputs a location-resolved detection signal; an image-data generation device that generates from the detection signal image data that indicate the marking molecules emitting the geometric locations of the luminescent radiation with a spatial resolution increased past the resolution limit.

### PRIOR ART

A classic field of application of optical microscopy for the examination of biological preparations is luminescence microscopy. Here, certain dyes (so-called phosphors or fluorophores) are used for the specific marking of samples, e.g., cell parts. The sample is illuminated, as mentioned, with excitation radiation, and the luminescent light excited in this way is detected with suitable detectors. For this purpose, in the optical microscope a dichroic beam splitter is typically provided in combination with block filters that split the fluorescent radiation from the excitation radiation and allow a separate monitoring. Through this procedure, the representation of individual, differently colored cell parts in the optical microscope is possible. Naturally, several parts of a preparation could also be colored with different dyes stored specifically on different structures of the preparation. This method is designated as multiple luminescence. One could also measure samples that luminesce per se, that is, without the addition of dye.

Luminescence is understood here, as is generally typical, as a generic term for phosphorescence and fluorescence, that is, it encompasses both processes.

It is further known for studying samples to use laser-scanning microscopes (also shortened to LSM) that reproduce, from a three-dimensionally illuminated image by means of a confocal detection arrangement (then one speaks of a confocal LSM) or a nonlinear sample interaction (so-called multi-photon microscopy), only the plane located in the plane of focus of the objective. An optical section is obtained, and the recording of several optical sections at different depths of the sample allows a three-dimensional image of the sample to then be generated with the help of a suitable data-processing device, with this image being assembled from different optical sections. Laser-scanning microscopy is thus suitable for studying thick preparations.

Naturally, a combination of luminescence microscopy and laser-scanning microscopy is also used in which a luminescent sample is imaged at different depth planes with the help of an LSM.

In principle, the optical resolution of an optical microscope, also of an LSM, is diffraction-limited by physical laws. For the optimum resolution within these limits, special illumination configurations are known, such as, for example, the 4Pi arrangement or arrangements with standing-wave fields. In this way, the resolution, in particular, in the axial direction, can be improved relative to a classical LSM. With the help of nonlinear depopulation processes, the resolution could be further raised to a factor of up to 10 compared with a diffraction-limited confocal LSM. Such a method is described, for example, in U.S. Pat. No. 5,866,911. For the depopulation processes, different approaches are known, for example, as described in DE 4416558 C2, U.S. Pat. No. 6,633,432, or DE 10325460 A1.

Another method for increasing resolution is discussed in EP 1157297 B1. There, by means of structured illumination, nonlinear processes are used. As the nonlinearity, the publication here mentions the saturation of the fluorescence. The mentioned method claims the realization of a shift in the object space spectrum relative to the transmission function of the optical system through structured illumination. In actuality, the shift of the spectrum means that object space frequencies V0 are transmitted at a space frequency V0-Vm, where Vm is the frequency of the structured illumination. For the maximum transmittable space frequency given by the system, this allows the transfer of space frequencies of the object lying above the maximum frequency of the transmission function by the shift frequency Vm. This approach requires a reconstruction algorithm for generating images and for evaluating several recordings for one image. For this method it is to be considered disadvantageous that the sample is charged with radiation unnecessarily in regions outside of the detected focus, because the necessary structured illumination penetrates the entire sample volume. Incidentally, this method could not be used currently for thick samples, because fluorescence excited outside of the focal area is led as a background signal onto the detector and thus the dynamic region of the detected radiation is drastically reduced.

Finally, one method that achieves a resolution beyond the diffraction limit independent of laser scanning microscopy is known from WO 2006127692 and DE 102006021317. This method shortened to PALM (photo activated light microscopy) uses a marking substance that could be activated by means of an optical activation signal, so that it could be excited only in the activated state with excitation radiation for the emission of defined fluorescent radiation. Nonactivated molecules of the marking substance emit no, or at least no significant, fluorescent radiation even after irradiation of excitation radiation. In the PALM method, the activation signal is now applied so that the marking molecules activated in this way are spaced apart from adjacent activated molecules so that they are separated or can be separated later measured at the optical resolution of the microscopy. The activated molecules are thus at least largely isolated. For these isolated molecules, the center of their resolution-limited, conditional radiation distribution is then calculated and the position of the molecules is determined computationally with higher accuracy from this than optical imaging actually allows. This increased resolution through computational center of gravity determination of the diffraction distribution is also designated as “super-resolution” in English technical references. It requires that, in the sample, at least a few of the activated marking molecules can be distinguished, that is, isolated, with the optical resolution at which the luminescent radiation is detected. For such molecules, the position information can be achieved with increased resolution.

For the isolation of individual marking molecules, the PALM method uses the fact that the likelihood with which a marking molecule is activated after receiving a photon of the activation radiation is identical for all molecules. By means of the intensity of the switch-over radiation and thus the number of photons falling on a unit of surface area of the sample, it can be ensured that the likelihood of activating marking molecules present in a surface area of the sample is so small that there are sufficient areas in which only distinguishable marking molecules emit within the optical resolution. Through matching selection of the intensity, i.e., the photon density of the switch-over radiation, it is achieved that as much as possible only the marking molecules lying isolated with respect to the optical resolution are activated and subsequently emit fluorescent radiation. For these isolated, molecules, the center of gravity of the diffraction-related intensity distribution is calculated computationally and thus the position of the marking molecule with increased resolution. For imaging the entire sample, the isolation of the marking molecules of the subset is repeated by the introduction of the activation radiation, subsequent excitation, and fluorescent radiation imaging until as much as possible all of the marking molecules have been included once in a subset and have been isolated within the resolution of the imaging.

The PALM method here has the advantage that a high spatial resolution is needed neither for the activation nor for excitation. Instead, both the activation and also the excitation can be performed with far-field illumination.

As a result, the marking molecules are activated through suitable selection of the intensity of the activation radiation statistically in sub-quantities. Therefore, for the generation of a total image of a sample in which the positions of all of the marking molecules can be determined computationally with a resolution lying beyond the diffraction limit, a plurality of individual images must be evaluated. There can be up to 10,000 individual images. This has the result that large quantities of data are processed and the measurement accordingly takes a long time. The recording of a total image already requires several minutes, which is set essentially by the reading rate of the camera being used. Determining the position of the molecules in the individual images is performed by complicated computational procedures as described, for example, in Egner et al., Biophysical Journal, pp. 3285-3290, Vol. 93, November 2007. The processing of all of the individual images and the composition into a highly resolved total image, that is, an image in which the locations of the marking molecules are specified with a resolution lying beyond the diffraction limit, typically lasts four hours.

### OBJECTS

The invention is based on the task of refining a method or a device for PAL microscopy so that faster image production is achieved.

This task is achieved by a method of the type named above in which the detection of the luminescent radiation in step c) or the generation of the image data in step d) comprises a nonlinear amplification of recorded luminescent radiation taking into disproportionately high account higher amplitudes, in order to sharpen the spatial resolution beyond the optical resolution.

The task is further achieved by a device of the mentioned type in which a nonlinear amplifier is provided that amplifies the recorded luminescent radiation or the detection signal in a nonlinear way, taking into disproportionately high account higher amplitudes, in order to sharpen the spatial resolution beyond the optical resolution.

Sharpening the resolution is here to be understood such that the locations of the luminescent marking molecule are known with a slighter fuzziness than the optical resolution allows. The point-blurring function thus has a lower half-width value.

The invention thus sets, in the PALM principle, instead of a complicated computational center of gravity determination of the isolated, activated marking molecules, a suitable nonlinear amplification, wherein, as is still to be explained, the nonlinear amplification can be used at different positions of the total image production. The nonlinear amplification disproportionately highly prefers higher intensities in the recorded luminescent radiation. This preference can be achieved, on one hand, in that higher intensities are amplified disproportionately high relative to lower intensities, thus the amplification factor increases with increasing intensity. On the other hand, the preference could also be achieved in that lower intensities are damped disproportionately high. Therefore, the term of nonlinear amplification is understood in the sense of this invention both as an amplification that increases with increasing amplitude of the signal to be amplified and also a nonlinear attenuation that decreases with increasing amplitude of the signal to be amplified.

The simplification according to the invention, however, includes an elevated demand with respect to the separation of the activated marking molecules. During the previously performed PALM principle, still luminescent marking molecules could also be separated through a computational analysis of the intensity distribution, wherein these molecules were not separated optically (in that, e.g., a deviation of the spatial distribution of the luminescence intensity from a Gaussian distribution was used to identify and to localize multiple luminescent marking molecules in the distribution), the approach according to the invention requires separation of the luminescent marking molecules, even if this separation is also weak, so that the nonlinear amplification can cause a resolution sharpening. This also demonstrates the term “sharpening,” because logically only an existing resolution, that is, the difference of two luminescent molecules, could already be sharpened that is previously already present. For this sharpening, the invention needs at least a saddle, i.e., local minimum, in the local distribution of the luminescence intensity of adjacent marking molecules. The invention is based on the novel knowledge that this requirement can be fulfilled comparatively easily by a suitable switch-over signal and therefore sets a considerable simplification and acceleration of the image generation.

Thus, according to the invention, no complicated position determination of the activated, isolated molecules detected by their fluorescent radiation is performed. In this way, the individual images can be processed in an especially quick way to form a highly resolved image. In addition, it is possible to process and to superimpose the individual images accordingly already during the recording, so that the highly resolved total image is completed with each additional individual image.

In one especially advantageous construction, the highly resolved image is generated directly on the detector itself, so that, for example, only one total image must be read from the camera. Here, the amount of data to be transmitted and thus the demands on the device technology are reduced drastically.

The gradual completion of the total image with each additional individual image also allows a user to intervene in the measurement process during the image production, for example, if the sample should move during the iterations.

The preference of higher intensities through nonlinear amplification can be performed at different locations, as already mentioned. For example, a nonlinear amplification before the detector is possible in optical or optical/electronic ways. For example, a so-called intensifier could be used that converts optical radiation into electrical signals, then amplifies these in a nonlinear way, and converts these back into optical radiation. Alternatively, the nonlinear amplification could also be performed on the detector itself, so that the detector receives radiation in a spatially resolving way and hereby amplifies it in a nonlinear way. Finally, the nonlinear amplification could also be performed on the detection signals after completion of the detection. In the case of a superimposition of several individual images to form one total image, each individual image is amplified in a nonlinear way.

Nonlinear amplification preferring higher intensities sharpens the spatial resolution beyond the optical resolution. In order to set the degree of resolution sharpening, it is advantageous to configure an amplification or attenuation characteristic curve so that it is adjustable.

As already mentioned, the nonlinear amplification could also be or comprise a nonlinear attenuation. In the sense of the invention, attenuation is amplification with an amplification factor less than 1. The attenuation degree can decrease continuously with the amplitude of the signal. For attenuation like amplification, however, naturally, noncontinuous profiles are also possible, e.g., so that overall a suppression of intensities lying below a threshold value is performed.

For the invention, it is necessary according to the PALM principle that the activated marking molecules are isolated through suitable application of the switch-over radiation with respect to the optical resolution of the luminescent radiation detection. This is to be understood such that the optical resolution allows a separation of the activated and luminescent marking molecules. This is then the case when the molecules are spaced apart so that the signal intensity decreases between the molecules to a value below the peak value present at the actual location of the molecules. In a section representation, the signal profile must show the already mentioned saddle.

It is especially preferred, as already mentioned, to generate a plurality of individual images each of which contains different subsets of the marking molecules in the fluorescence state with resolution increased beyond the optical possibility. The steps a) to e) of the method according to the invention are advantageously to be run through several times, in order to generate a total image of the sample. The image data contained in each cycle after step e) represent an individual image and are each superimposed with the individual images of previous cycles to form the total image. After the last cycle, the total image is then completed.

According to the marking molecules being used, a deactivation is possible or required, so that, in the next step a), a statistically selected subset of all of the marking molecules are activated and as many subareas in the sample as possible are provided in which a detection of the fluorescent radiation can be performed within the diffraction-limited, resolvable volume. Therefore it is preferred that the marking molecules can be deactivated; in particular, such marking molecules are used, in order to be no longer able to be excited for the emission of fluorescent radiation, so that all of the marking molecules are deactivated before each additional cycle. For the next cycle, all of the marking molecules for a new activation are then available. However, marking molecules are also known that deactivate due to the elapsing of time. The deactivation then includes waiting for a corresponding time span between successive cycles, so that all or a sufficient number of marking molecules are deactivated.

In the iterative procedure mentioned above with multiple cycles, the total image is produced from a plurality of individual images. It is preferred that the total image is displayed during the cycles as an intermediate image, especially to allow a user to make an intervention. If such an intervention is made, it is useful to generate a corresponding signal, e.g., an interrupt signal input by a user, to store the intermediate image, and to restart the cycles from the beginning, in order to generate a new total image.

Advantageously, in this way an adaptation of the activation power and/or the excitation power or deactivation power is performed with reference to structures identified during the cycles. Here, the optimization criterion could be the ratio of the unseparated molecules to the separated molecules or the portion of the separated or unseparated molecules in the total image. In the PALM concept, the already described isolation of the marking molecules is set by means of the intensity of the activation radiation. Alternatively or additionally, that could also take place by means of the intensity of the excitation radiation or optionally deactivation radiation. The production of a total image in multiple cycles, wherein each cycle delivers an individual image, could now be used to adapt or to optimize the intensity to be set.

The method according to the invention is naturally especially suitable for imaging thick samples, so that image stacks are recorded that have images lying one above the other perpendicular to the direction of incidence of the radiation, i.e., in the z-direction. The method according to the invention here offers special advantages, because, on one hand, the PALM principle is associated with a low charging of the samples with activation radiation; thus, bleaching effects present no problems. On the other hand, the imaging of a thick sample by an image stack requires an especially large number of images. The increase in the imaging rate achieved according to the invention is important for this application, if not actually decisive. One could easily imagine that, at four hours for each total image, the recording of an image stack made from total images requires an enormous amount of time.

As far as method features are named in the preceding or in the following description, the described device has a corresponding control device that realizes, in the operation of the device, the corresponding method features, i.e., is constructed suitably. As far as certain operating features or properties are described for the device, the device performs corresponding steps of a method analogously, optionally under the control of the control device.

It is understood that the features named above and the features still to be explained below can be used not only in the specified combinations, but instead also in other combinations or by themselves, without leaving the scope of the present invention.

### BRIEF DESCRIPTIONS OF THE DRAWINGS

Below, the invention will be explained in more detail, for example, with reference to the accompanying drawings that also disclose features essential to the invention. Shown are:

FIG. 1, a schematic diagram of an activated marking molecule in the resolution-limited volume;

FIG. 2, a schematic diagram of the image of different activated and nonactivated marking molecules on a spatially resolving detector;

FIG. 3, a flowchart for the image generation in the PALM method;

FIG. 4, explanations belonging to the flowchart of FIG. 3 with the image of marking molecules on the detector of FIG. 2;

FIG. 5, a section representation through an intensity distribution produced based on the resolution limitation in the detection of a fluorescent marking molecule at different nonlinear amplifications;

FIG. 6, the function of the half-width value of an intensity distribution produced due to the resolution limitation as a function of the nonlinear amplification;

FIG. 7, a lateral section through two diffraction slices produced due to the resolution limitation of two adjacent, simultaneously fluorescent marking molecules at linear and different nonlinear amplifications;

FIG. 8, a schematic diagram of a variant with nonlinear amplification on the detector;

FIG. 9, a variant with nonlinear amplification after the detection;

FIG. 10, a microscope for PAL microscopy with nonlinear amplification according to the variants of FIG. 8 or 9;

FIG. 11, a schematic diagram of an intensifier for nonlinear, optical/electronic amplification; and

FIG. 12, a microscope similar to that of FIG. 10, but under the use of the intensifier of FIG. 11.

### DESCRIPTION OF THE EMBODIMENTS

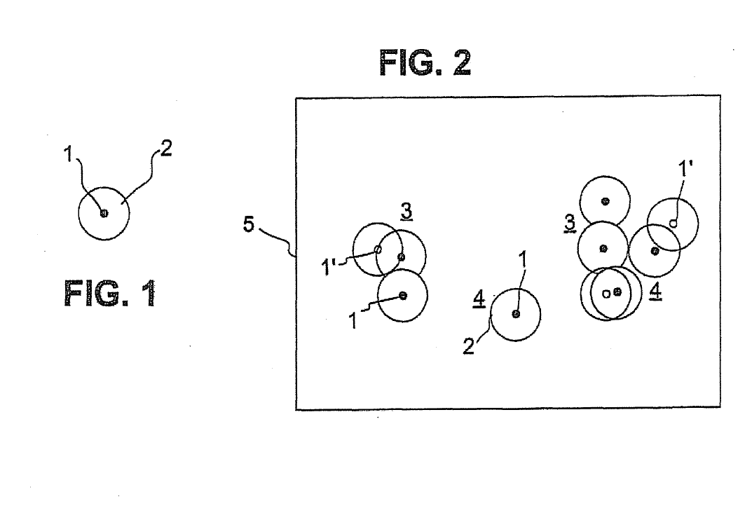

FIG. 1 shows schematically a marking molecule 1 that was excited for fluorescence. Naturally, the fluorescence detection requires a plurality of excitations, because each excitation delivers exactly one fluorescent photon and the radiation detection requires an integration of many photons. The fluorescent radiation emitted by the marking molecule 1 can be detected in a microscope based on physical principles only at a limited optical resolution. Even if the microscope reaches the diffraction limit of the optical resolution, the photons of the fluorescent marking molecule 1 are still scattered in a diffraction-limited way and thus detected in a diffraction slice 2. The microscope thus reproduces, in principle, instead of the geometric extent of the marking molecule 1, which is designated schematically as a black circle in FIG. 1, a larger object that is shown in FIG. 1 by the diffraction slice 2. The size of the diffraction slice 2 depends on the quality of the microscopy device being used and is defined by the half-width value of the point-blurring function of the optical image. Naturally, in actuality it involves not a two-dimensional object, but instead a diffraction volume into which the fluorescent photons reach. In the two-dimensional diagram of FIG. 1, however, this appears as a slice. The term diffraction slice is used here very generally for a maximum resolution volume that the optics being used can achieve. The optics being used, however, do not necessarily work at the diffraction limit, even if this is to be preferred.

Now, in order to be able to localize the marking molecule 1 within the diffraction slice 2 more precisely, the PALM method already discussed generally above is used. This photoactivates individual marking molecules, wherein, in this description, the term activation is understood very generally as the activation of defined luminescence properties of the marking molecules, that is, both switching on the ability to excite luminescence and also a change of the luminescence emission spectrum, which corresponds to switching on certain luminescence properties. The activation is now performed so that it produces at least a few activated molecules whose center of gravity does not lie in the diffraction slice of other activated molecules, i.e., which could still be differentiated at least directly within the optical resolution.

FIG. 2 shows schematically an example situation of a detector 5 that integrates the photons in a spatially resolving way. As is to be seen, there are areas 3 in which the diffraction slices of adjacent marking molecules overlap. Here, as is to be seen in the left area 3 of FIG. 2, only those marking molecules that had been activated before are relevant. Nonactivated marking molecules 1′ do not emit the defined fluorescent radiation that is captured on the matrix detector 5, thus they play no role.

Marking molecules 1 lie in the areas 4, e.g., the area 4 lying in the middle of matrix detector 5, so that their diffraction slice 2 overlaps with no diffraction slice of another activated marking molecule 1. The right area of the matrix detector 5 shows that areas 3 in which diffraction slices of activated marking molecules overlap could definitely lie adjacent to areas 4 in which this is not the case. The right area 4 also shows that the neighborhood of an activated marking molecule 1 to a nonactivated marking molecule 1′ plays no role for the detection, because such a marking molecule 1′ does not emit the fluorescent radiation detected by the matrix detector 5, that is, does not fluoresce.

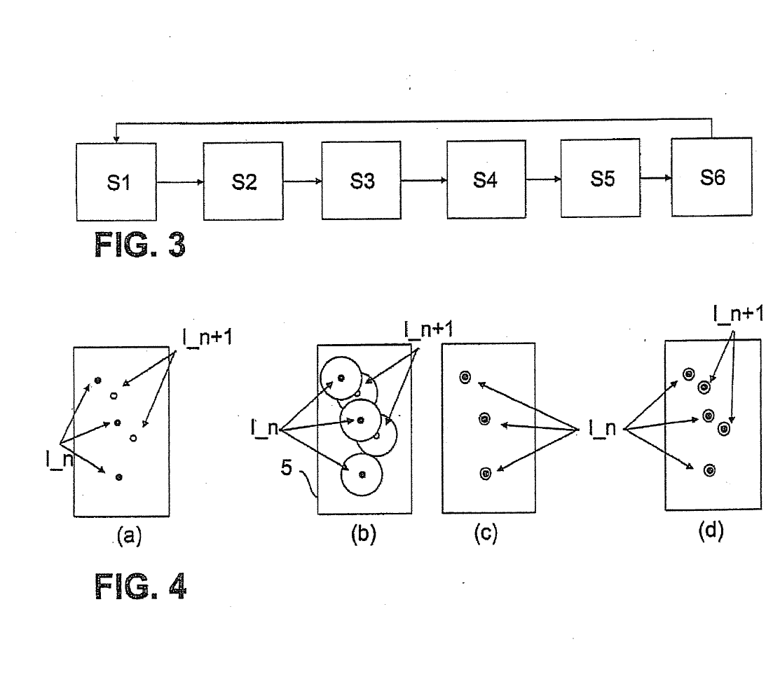

For recording an image that has details beyond the optical resolution specified by the apparatus and is, in the sense of this description, a highly resolved image, the steps shown schematically in FIG. 3 will now be discussed.

In a first step S1, by means of a switch-over signal, a subset of the marking molecules is activated; that is, they are switched from a first state in which they cannot be excited for the emission of the defined fluorescent radiation into a second state in which they can be excited for the emission of the defined fluorescent radiation. Naturally, the activation signal could also cause a selective deactivation, that is, in step S1, an inverse procedure could also be used. It is essential that after step S1, only a subset of the marking molecules can be excited for the emission of the defined fluorescent radiation. The activation or deactivation (for simplification, only the case of activation will be discussed below) is performed as a function of the marking molecules being used. For a dye such as, e.g., DRONPA, PA-GFP, or reversible, switchable synthetic dyes (such as Alexa/Cyan constructs), the activation is performed by optical radiation, thus, the switch-over signal is switch-over radiation.

In the sub-figure a, FIG. 4 illustrated below FIG. 3 shows the state after step S1. Only a subset of the marking molecules 1_{—}n is activated. The marking molecules of this subset are shown with a solid black dot. The rest of the marking molecules have not been activated in this step. They are designated in sub-figure a of FIG. 4 with 1_{—}n+1.

Marking molecules that have been activated can then be excited in a second step S2 for the emission of fluorescent radiation. As fluorescent dyes, advantageously fluorescent proteins, such as PA-GFP or also DRONPA, known from the prior art are used. The activation in such molecules is performed with radiation in the range of 405 nm; the excitation for fluorescent radiation is performed at a wavelength of approximately 488 nm; and the fluorescent radiation lies in a range about 490 nm.

In a third step S3, the emitting fluorescent radiation is detected, for example, by the integration of the recorded fluorescent photons, so that the situation shown in the sub-figure b at the bottom of FIG. 4 is produced on the matrix detector 5. As is to be seen, the diffraction slices of the activated marking molecules 1_{—}n do not overlap. The size of the diffraction slices is set by the optical resolution of the image on the matrix detector 5. In addition, in the sub-figure b of FIG. 4, (theoretical) diffraction slices of fluorescent molecules are drawn that belong to the nonactivated group 1_{—}n+1. Because these nonactivated marking molecules emit no fluorescent radiation, no fluorescent radiation lying in the (theoretical) diffraction slices disrupts the detection of the fluorescent radiation of the subset 1_{—}n of the activated marking molecules.

Thus, in the subset 1_{—}n, as few diffraction slices as possible overlap, so that the marking molecules can no longer even be distinguished, the activation energy is set so that the subset 1_{—}n makes up only a comparatively small portion of the total quantity of the marking molecules, so that statistically many marking molecules can be distinguished with respect to the volume that can be resolved with the optical arrangement.

In a fourth step S4, the recorded fluorescent radiation amplifies in a nonlinear way, wherein the resolution at which the position of the activated marking molecules can be specified is sharpened beyond the resolution of the optical arrangement, as the sub-figure c of FIG. 4 shows.

The nonlinear amplification can be described, for example, according to the function S=A·F^{N} (equation 1) or S=A·exp^{F/w} (with w=10^{-N} (equation 2)), wherein F is the amplitude of the fluorescent signal, A is a normalization factor, and N is a whole number greater than 1. Naturally, other functions could also be used.

Through the nonlinear amplification, the half-width value of the diffraction slices is reduced in all three dimensions, so that the reduced diffraction slice shown schematically in sub-figure c of FIG. 4 is produced. However, a strong nonlinear dependency of the parameter S on F, that is, e.g., high values for N in equations 1 or 2, is especially advantageous.

The nonlinearity is advantageously selected so that the half-width value of the diffraction slice corresponds to a desired spatial resolution for the spatial positioning of the marking molecules.

In addition to a nonlinear amplification, as already mentioned, a nonlinear attenuation could also be used. Here, fluorescent signals of low amplitude or intensity are damped, while strong signals are left at least largely non-damped. Naturally, a combination of nonlinear amplification and attenuation could also be used. In an optional fifth step S5, a normalization or a cutting of the amplified fluorescent signals is performed, as long as their intensity or their level lies below a threshold value.

In a sixth step, the sub-image obtained in this way is set into a total image. Then processing jumps back to step S1, so that with each cycle, a sub-image is obtained that is summed into a total image. In the next cycle, optionally after suitable deactivation of the marking molecules, a different subset of the marking molecules is activated, e.g., the subset 1_{—}n+1 shown in FIG. 4.

Through the multiple cycling through steps S1 to S6, the total image is built from individual images of the individual cycles, which specify the locations of the marking molecules with a spatial resolution that is sharpened relative to the resolution of the optical image. Through a corresponding number of iterations, a highly resolved total image is successively built. The reduction of the diffraction slice is here performed in the method in all three spatial dimensions when several image stacks that are spaced apart in the z-direction are recorded. Overall, the total image then contains, highly resolved in all three spatial directions, the spatial positioning of the marking molecules.

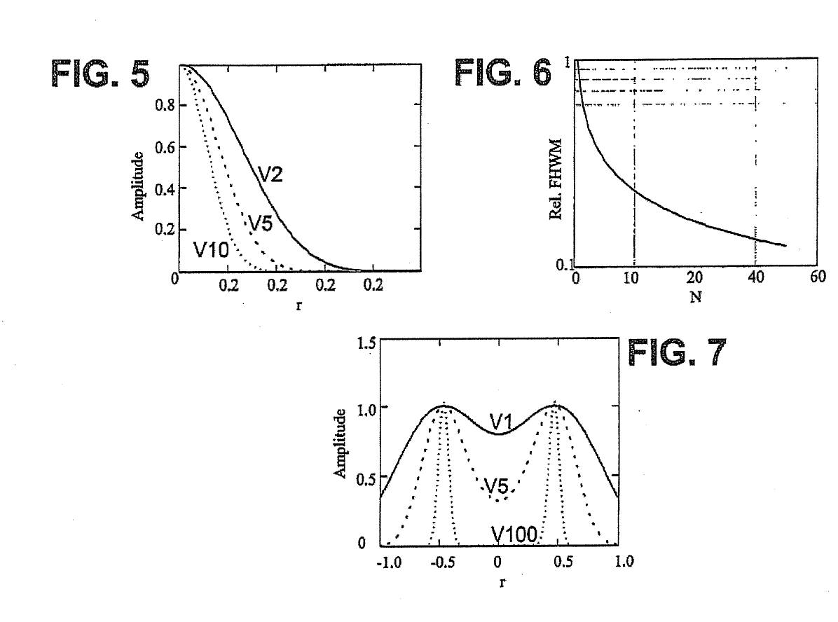

FIG. 5 shows a radial section through a diffraction slice 2 for different nonlinear amplifications V2, V5, and V10. The number after the letter V here corresponds to the value for N in equation 1. In each, the amplified fluorescent signal is designated as a function of the distance from the actual position of the marking molecule that lies at r=0. With increasing nonlinearity, that is, N=2, 5, or 10, one recognizes that the width of the distribution decreases. Therefore, the sharpness of the spatial positioning beyond the optical resolution is achieved.

FIG. 6 shows the quotient from the half-width value for nonlinear amplification and linear amplification as a function of the amplification factor N. On the y-axis of FIG. 6, the relative half-width value (rel. FHWN) is recorded. One sees that with increasing values of N in equation 1 (analogous results are obtained for equation 2), the half-width value of the nonlinearly amplified signal falls relatively quickly to below 20% of the half-width value of the linearly amplified signal. An image with 10-times improved resolution is obtained for a nonlinear amplification with a value of N 100 in equation 1.

FIG. 7 shows a lateral section through two adjacent diffraction slices that originate from two adjacent, activated activation molecules. The actual locations of the marking molecules are recorded at an r value of −0.5 and +0.5, respectively, in FIG. 7. On the y-axis, the amplitude of the fluorescent signal is recorded and indeed for a nonlinear amplification (V1) as well as amplifications with N=5 or N=100 (V5 or V100). Without nonlinear amplification, i.e., at V1, the individual molecules can be separated only weakly or just barely, because the total amplitude at r=0 still has a weak saddle. The molecules are therefore barely distinguishable with the given optical resolution, because the centers of gravity of the point-blurring functions are still loaded somewhat more than the half-width value of these functions. Here it is essential for the distinguishability that a local minimum lies between the two amplitude peaks.

Through the nonlinear amplification, the minimum is made deeper, so that both molecules in the total image now appear clearly separated, which makes clear the increase in resolution past the optically given limit. A simultaneous activation of the fluorescent molecules lying at r=−0.5 and r=+0.5 allows a separation of these molecules that is significantly better than is possible optically in combination with the nonlinear amplification.

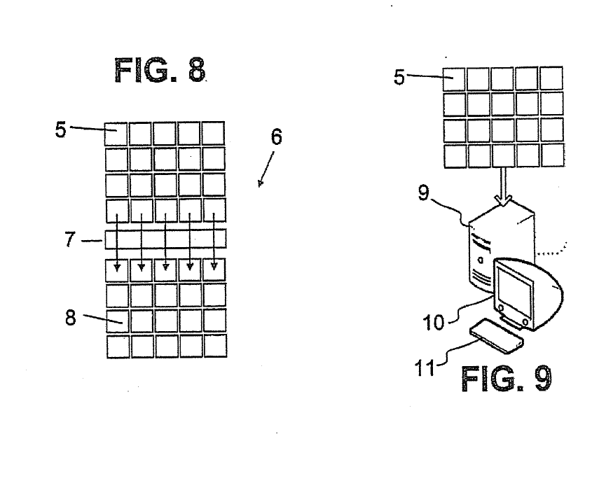

FIG. 8 shows a first variant to the nonlinear amplification. Here, a special detector device 6 is used that can be realized, for example, as a Frame Transfer Matrix detector (CCD) that has a matrix detector 5. The pixel size of the matrix detector 5 advantageously corresponds to half the desired resolution of the microscope. In the matrix detector 5, individual detected photons of the fluorescent radiation are integrated. This corresponds to step S3. At the end of the integration time for one integration step, the frame obtained in this way is pushed into a memory region 8 by means of an amplifier unit 7. The amplifier unit 7 provides an advantageously adjustable, nonlinear amplification characteristic curve and thus causes the nonlinear amplification according to step S4. The amplitude as well as the maximum value of the characteristic curve are advantageously adjustable. In the memory region 8, the charges generated by the amplifier unit 7 for each pixel of the matrix detector 5 are summed. This corresponds to step S6 of FIG. 3.

At the end of the iterations, from the memory region 8, the highly resolved total image is read. The reading could also be performed before the completion of all of the iterations, in order to obtain an intermediate image. With reference to these intermediate images, the user can monitor how the high-resolution total image is built and can optionally intervene in the measurement process. Advantageously, an adjustment of the intensity of the activation radiation is performed, in order to achieve the highest possible portion of isolated, activated marking molecules. In this variant, more marking molecules could also be activated for each cycle, so that the number of necessary cycles is reduced.

If intermediate images are read from the memory region 8, then the total image is calculated and displayed by the summation of the individual intermediate images, for example, on a computer.

FIG. 9 shows a second variant in which the matrix detector 5 integrates the photons of the recorded fluorescent radiation for each iteration step and delivers these photons as an image to a computer 9. The computer 9 has a display 10, e.g., a monitor, as well as an input device 11, e.g., a keyboard or the like.

Thus, in this variant, the processing steps S2 to S6 are performed in the computer 9. For this variant, the image rate of the matrix detector is decisive for the total measurement time, so that a matrix detector 5 with the highest possible image rate is advantageous, in order to reduce the measurement time. In this variant it is advantageous that the individual images are available immediately after their production, so that an image evaluation can already be performed in the individual images.

Furthermore, the individual images of each cycle could be displayed dependent on focal planes and could be assembled into a 3D total image from nonlinearly amplified individual images, wherein a normalization is also possible. The resolution increase is thus given in all three spatial directions.

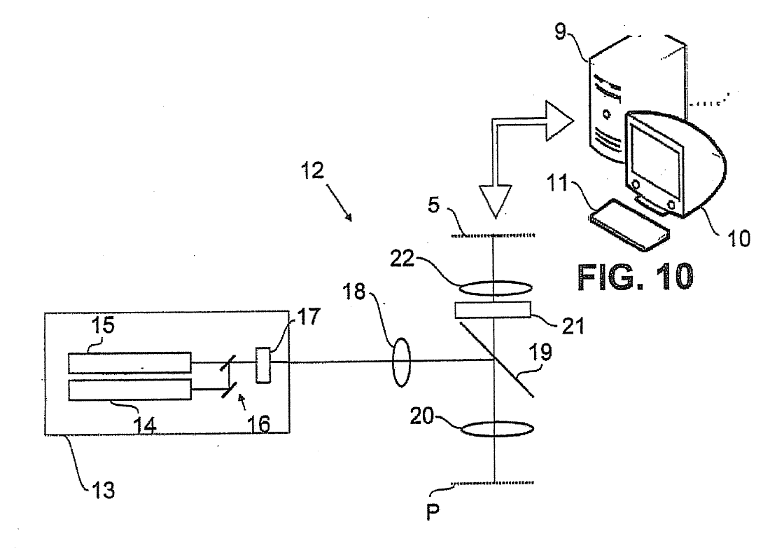

FIG. 10 shows schematically a microscope 12 for the high-resolution imaging of a sample P. The sample is marked, for example, with the dye DRONPA (compare WO 2007009812 A1). For activation as well as for fluorescence excitation, the microscope 12 has a radiation source 13 that provides individual lasers 14 and 15 whose beams are combined by means of a beam combiner 16. The lasers 14 and 15 could emit, for example, at 405 nm (activation radiation) and 488 nm (fluorescent radiation and deactivation) radiation. Dyes are also known (e.g., the dye by the name of DENDRA [cf. Gurskaya et al., Nature Biotech., Vol. 24, pp. 461-465, 2006]), in which the activation and fluorescence excitation can be performed at one and the same wavelength. Then one laser is sufficient.

An acoustic optical filter is used for the wavelength selection and for the quick switching or damping of individual laser wavelengths. One optical system 18 focuses the radiation by means of a dichroic beam splitter 19 into a pupil of an objective 20, so that the radiation of the radiation source 13 is incident on the sample P as far-field illumination.

Fluorescent radiation produced in the sample P is collected by means of the objective 20. The dichroic beam splitter 19 is designed so that the fluorescent radiation can pass, so that it reaches through a filter 21 to a tube lens 22, so that, overall, the fluorescent sample P is imaged onto the detector 5. According to the construction of the detector 5, the construction of FIG. 10 thus realizes the variant according to FIG. 8 or 9.

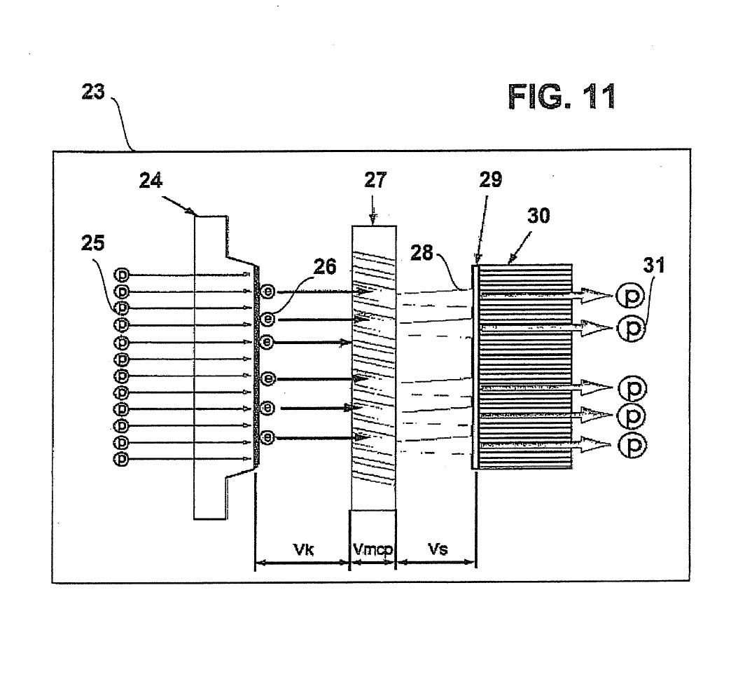

FIG. 11 shows another variant to the nonlinear amplification. Here, the steps S3 and S4 are realized in a so-called intensifier 23. This has an inlet window 24 on which photons 25 of the incident radiation are recorded. The photons are symbolized by a p in a circle. At the inlet window 24, the photons are converted into electrons 26 (symbolized by an e in a circle). The electrons are then nonlinearly amplified with a multichannel plate (MCP) 26 and reach, as a corresponding nonlinearly amplified electron beam 28, a phosphorescence screen 29 that has an outlet window 30 and converts the electrons into photons 31. The nonlinear amplification is set on the intensifier 23, in particular, by means of an MCP voltage Vmcp. A cathode voltage Vk as well as a screen voltage Vs ensure that the electrons reach the MCP 27 or from there the screen 29.

The intensifier 23 is a comparatively narrow component with respect to the direction of the incident radiation, i.e., the direction of incidence of the photons 25, and maintains, above all, the beam-spreading direction. It further causes a nonlinear amplification of the incident radiation, i.e., high densities of the photons 25 are amplified disproportionately high and thus preferred relative to lower photon densities.

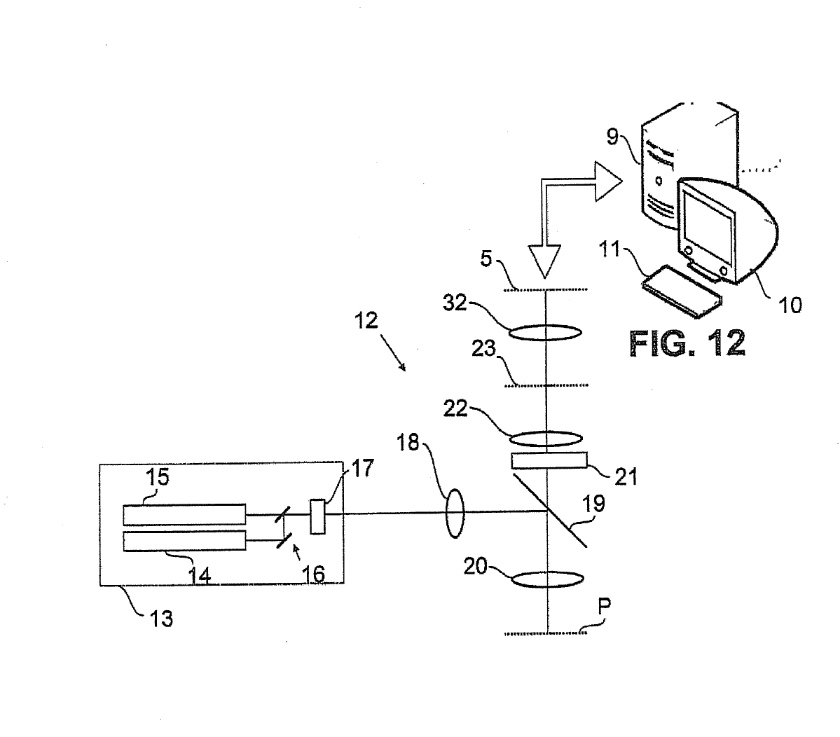

FIG. 12 shows a microscope 12 in which the nonlinear amplification is performed by means of the intensifier 23 that here lies in an intermediate-image plane of the image of the fluorescent sample P on the matrix detector 5. Therefore, an additional optical system 32 is provided that images the radiation emerging from the outlet window 30 onto the matrix detector 5. Otherwise the construction of the microscope of FIG. 12 corresponds to that of FIG. 10.

The microscopes of FIGS. 10 and 12 allow a total image that has a spatial resolution increased by a factor of 10 relative to the optical resolution of the microscope. The optical resolution of the microscope can equal, for example, 250 nm laterally and 500 nm axially. For the use of the intensifier, nonlinear amplifications are possible that allow even a resolution of the spatial positioning in the total image of approximately 10 nm.

The variants explained here as examples for the nonlinear amplification, in particular with respect to the intensifier 23 or the matrix detector of FIG. 8, can also be expanded or replaced according to the invention by additional optically nonlinear media, such as, for example, second harmonic generation crystals, dyes, saturable absorbers, etc. Here it is important that according to the processing steps S3 and S4, the fluorescent radiation of the activated marking molecules is first integrated and then nonlinearly amplified. Detection and nonlinear amplification are performed in the described variants separately, wherein, if no nonlinear optical amplification is performed, such as, e.g., by the intensifier 23, the nonlinear amplification is advantageously performed after the recording of the fluorescent radiation, e.g., after suitable integration.

What is claimed is:

1. Method for the high spatial resolution luminescence microscopy of a sample that is marked with marking molecules that can be activated with a switch-over signal, so that only then can they be excited for the emission of defined luminescent radiation, wherein the method has the following steps:
a) introduction of the switch-over signal to the sample such that only a subset of the marking molecules present in the sample is activated, wherein, in the sample, there are subareas in which activated marking molecules have a distance to the activated marking molecules most closely adjacent to these activated marking molecules, wherein this distance is greater than or equal to an optical resolution of a detection of luminescent radiation;
b) excitation of the activated molecules for the emission of luminescent radiation;
c) detection of the luminescent radiation with the optical resolution; and
d) generation of image data from the luminescent radiation that is recorded in step c) and that indicates the geometric locations of the marking molecules emitting the luminescent radiation at a spatial resolution increased beyond the optical resolution;
characterized in that
e) the detection of the luminescent radiation in step c) or the generation of the image data in step d) comprises a nonlinear amplification of recorded luminescent radiation preferring higher intensities, in order to sharpen the spatial resolution beyond the optical resolution.

2. Method according to claim 1, characterized in that, in step c), the luminescent radiation is integrated spatially resolved and, in step e), the integration result is amplified nonlinearly.

3. Method according to claim 1, characterized in that an amplification characteristic curve of the nonlinear amplification is adjustable.

4. Method according to claim 3, characterized in that the nonlinear amplification comprises a suppression of intensities lying below a threshold value.

5. Method according to claim 1, characterized in that the steps a)-e) are run through several times, in order to generate a total image of the sample, wherein image data obtained after step e) is superimposed with image data from prior cycles to form the total image, so that after the last cycle, the total image is completed.

6. Method according to claim 5, characterized in that the marking molecules can be deactivated, in order to no longer be able to be excited for the emission of luminescent radiation and that, before each additional cycle, all of the marking molecules are deactivated.

7. Method according to claim 6, characterized in that, during the cycles, the resulting total image is displayed as an intermediate image.

8. Method according to claim 7, characterized in that the intermediate image is stored on a signal occurring during the cycles, e.g., an interrupt signal input by a user, and the cycles are started over, in order to generate a new total image.

9. Method according to claim 7, characterized in that, between the cycles, the intensity of the introduction of the switch-over signal and/or the excitation of the activated molecules is changed, in order to maximize the magnitude of the subset.

10. Device for high spatial resolution fluorescence microscopy of a sample that is marked with marking molecules that can be activated with a switch-over signal, so that only then can they be excited for the emission of defined luminescent radiation, wherein the device has:
means for the introduction of the switch-over signal onto the sample such that only a subset of the marking molecules present in the sample is activated, wherein, in the sample, there are subareas in which activated marking molecules have a distance to the activated marking molecules most closely adjacent to these activated marking molecules, wherein this distance is greater than or equal to an optical resolution of a detection of luminescent radiation;
means for the excitation of the activated molecules for the emission of luminescent radiation;
a detector device that records luminescent radiation with the optical resolution and outputs a spatially resolved detection signal;
an image data generating device that generates, from the detection signal, image data that specifies the geometric positions of the luminescent-radiation-emitting marking molecules with a spatial resolution increased beyond the optical resolution;
characterized in that
a nonlinear amplifier is provided that amplifies the recorded luminescent radiation or the detection signal in a nonlinear way, preferring higher intensities, in order to sharpen the spatial resolution beyond the optical resolution.

11. Device according to claim 10, characterized in that the detector device integrates luminescent radiation in a spatially resolved way and the amplifier amplifies the integration result in a nonlinear way.

12. Device according to claim 11, characterized in that the nonlinear amplifier has an adjustable amplification characteristic curve.

13. Device according to claim 12, characterized in that the nonlinear amplifier suppresses intensities lying below a threshold value.

14. Device according to claim 13, characterized by a control device that controls the operation of the means for the introduction of the switch-over signal, the means for the excitation of the activated molecules, the detector device, and the image-data generation device and the amplifier, and here causes an operation according to one of the above method claims.

15. Device according to claim 14, characterized by a display device for the display of the intermediate image.

16. Device according to claim 14, characterized by a nonlinear, optical or electro-optical amplifier, in particular, an intensifier, arranged in front of the detector.
